(19) United States
(12) Patent Application Publication
(10) Pub. No.: US 2022/0237574 A1
(43) Pub. Date: Jul. 28, 2022

(54) SYSTEMS AND METHODS TO PROCESS PAYMENTS AND MONEY REMITTANCES NEARLY INSTANTANEOUSLY WITHOUT USING FINANCIAL INTERMEDIARIES OR BANK ACCOUNTS BY USING A STABLE CRYPTOCURRENCY AND UNCONVENTIONAL CRYPTOCURRENCY DISTRIBUTION METHODS

(71) Applicants: Axel Nissim Sanchez Orozco Gomez, CDMX (MX); Jose Benacerraf, Palmetto Bay, FL (US)

(72) Inventors: Axel Nissim Sanchez Orozco Gomez, CDMX (MX); José Benacerraf, Palmetto Bay, FL (US)

(21) Appl. No.: 17/584,307

(22) Filed: Jan. 25, 2022

Related U.S. Application Data
(60) Provisional application No. 63/141,899, filed on Jan. 26, 2021.

(51) Int. Cl. G06Q 20/06; G06Q 20/36; G06Q 20/22; G06Q 20/40

(52) U.S. Cl. CPC G06Q 20/065; G06Q 20/367; G06Q 2220/00; G06Q 20/40145; G06Q 20/223

(57) ABSTRACT

The present disclosure relates to a system and methods used to transfer economic value between payors and payees (P2P, B2B, P2B, B2E) nearly instantaneously, by using a stable denominated cryptocurrency that relies on a specific set of algorithms and business processes to overcome the lack of access to general banking services by certain populations and businesses, intermediation costs, general waiting times, and the need to maintain nostro-vostro accounts for the operator of such a service when conducting international operations. The system and methods being disclosed solve the material impossibility to have inexpensive, instantaneous, electronic transactions for people outside the traditional financial systems.

### TECHNICAL FIELD

This invention relates generally to the payment or remittances methods field and more specifically to the distribution and viable usage of a cryptocurrency asset that can be settled nearly instantly, and for which the users on either end of the transaction do not need to be bank account holders.

### BACKGROUND

Most traditional payments methods require their users to have and operate through traditional bank accounts to be able to use them. Such a limitation means that a large portion of the population is effectively incapacitated to perform everyday electronic transfers of value and payments that are the norm for the banked portion of the population.

Furthermore, even when having a bank account enables electronic transactions for a large part of the population, such transactions are encumbered by many limitations in settlement speed and cost related to the participation of many layers of intermediaries, from app operators, acquiring and corresponding banks, credit card companies, clearing houses and communication network operators. This issue makes those services slow, expensive and non-convenient for many of their users.

Given the state of the art of the payments landscape, many people choose to operate using cash for everyday transactions to avoid the delays in settlement and intermediary fees that are the norm when using banking services and money remittance services, missing on the benefits of electronic transacting. For example, final settlement of a debit/credit card transaction can take anywhere from a few hours, to several days or even weeks depending on combined set of operational rules and restrictions imposed by the many different intermediaries of the transaction. For a large part of the population, such final settlement times are simply unacceptable, so they chose to use cash, as it provides a liquid and instant means of value transfer. When using traditional banking-based payment methods, transaction confirmation times tend to be almost instantaneous, however, this only means that the transaction has been confirmed to be underway, final settlement in the payees banking account and availability of funds will not occur until all the transaction intermediaries have settled their respective balances.

In the remittance side of it, users wishing to send or receive money face very expensive and sometimes hidden fees and general delays that are unavoidable when using the incumbent intermediary based systems.

In recent times, with the invention of cryptocurrencies in general, some people have begun to use them as payment methods for specific types of transactions. However, general utility and usage of cryptocurrencies as means of payment remains relatively low because of a series of problems related to the very nature and design of such existing cryptocurrencies.

Chiefly among such problems are:

Lack of ramp-on and ramp-off channels that allow the unbanked or the underbanked easy and inexpensive access to the acquisition of cryptocurrency

Volatility and volume problems: Most cryptocurrencies have a very high volatility and/or low volumes, which translates to an unacceptably high risk of losing value because of price swings or simply because executing a large enough transaction might prove economically or technically impossible, as volume remains low at nominal price points requiring a further loss of value to execute a transaction. It is simply unacceptable for a payee or payor, not being able to be sure of the redemption value of a given quantity of cryptocurrency in a reasonable amount of time. These issues combined deter many people from using them in real-world payment scenarios, as they need certainty in the value of their money.

When using cryptocurrency to settle a transaction, transaction confirmation time and transaction settlement times tend to be the same. Which effectively means that if confirmed, a transaction immediately achieves finality, in stark contrast with banking-based payment methods. However, Bitcoin transactions generally take between 10 minutes to 1 hour to be confirmed, which discourages its use as a general value exchange method, as the general expectation from the users of generally available payment methods is that transactions be confirmed almost instantly (imagine waiting 10 minutes at a Starbucks to receive confirmation of payment for a coffee). Other popular Cryptocurrencies suffer the same problem, with confirmation times that vary between 3 or 4 times faster than Bitcoin, in the case of Ethereum, which is still insufficient to be considered a viable general usage payment method.

Given the sets of problems listed in the background, the invention has the following objectives.

a) To allow for the creation of a new payment method that is unencumbered to operate at a speed similar to cash. That is, that money can be spent immediately after changing hands, with no delay periods. This is a prerequisite for the adoption of the product among the unbanked and underbanked merchants, given that traditional payment methods such as cards will not allow them to spend their funds until typically 24 to 48 hours later. Whenever the merchants have a low acceptance rate for a payment method, the end users of the payment method lack an incentive to use said payment method, because the lack of accepting merchants greatly limit the usability of the product (as it currently happens for over 90% of small merchants in Mexico alone that do not accept cards nor bank transfers).

b) Such a payment method should not operate my making typical bank transfers or by using the credit and debit card networks, because the intermediation introduces delays and settlement problems, as well as fees and processes that are seen as a nuisance by the potential users.

c) The payment should be implemented in a transaction that is “price-stable” and “value-stable”, meaning that it is not speculative in nature. People should always be able to determine how much money they will send or receive, contrary to existing systems like Bitcoin or Ethereum.

d) The payment method should be able to be operated using a smartphone and a smartphone application that are connected to the internet and should be able to directly send electronic payment instructions to a system implementing Distributed Ledger Technologies so that transactions can be settled almost instantaneously and inexpensively, with a reasonable expectation about the value being transferred. Regular banking and payment methods require a series of intermediaries and redundant book-keeping on both sides of the transaction. Our payment method refers to a single source of truth for all transactions, eliminating speed settlement problems and interchange fees. Typical cryptocurrency-based payment systems on the other side, are either too slow to solve the objective “a” as in the case of Bitcoin, requiring a minimum of 1 hour for settlement, or suffer of price stability problems as in the case of Bitcoin and Ethereum as well, or suffer from both problems as many other platforms.

e) The payment operation should be inexpensive and fast, thus enabling micropayments. In the case of payment cards, transaction costs are typically expressed as a fixed amount plus a percentual commission, therefore payments that are smaller than the fixed amount are very expensive and impractical. In the case of cryptocurrencies such as Ethereum, the nature of the system itself lends itself to competitive bidding in order to enable fast transactions. Users of the system are forced to choose between inexpensive transactions or transaction speed. Typical fast transactions in such a system can take in the order of tens of seconds to a couple minutes, but are very expensive (about 17 USD per transaction, independent of the amount transacted at the moment of writing this application).

f) The payment method should not allow for double spending of funds, be secure, should not use “mining” algorithms or any other inflationary or competitive in nature algorithms used to secure the network, while eliminating possible discrepancies or inconsistencies on transaction settlement and implementing a very high transactional throughput capable of maintaining transaction ledgers at the level of several thousand processed transactions per second.

g) The payment method should provide a solution to cash management problems at all steps of the supply chain, in order to maximize acceptance by all players in the ecosystem.

h) The payment method shall provide a single source of truth regarding all settled transactions, which in turn will also enable a much better decision-making process to provide credit, determine product prices, inventories and stock. Currently, unbanked population are not the subjects of credit, because they have no banking information that allows for a credit score to be formed. This has a direct influence on the amount of inventory that unbanked merchants can buy and leaves little financing alternatives that usually are very expensive.

i) The payment method should be easily obtainable, without the requirement of having a bank account. People should be able to perform a similar action to topping up their phones in a physical store, in order to fund the payment method.

### BRIEF DESCRIPTION OF THE DRAWINGS

FIG. 1. Is the description of an example embodiment of a 4-party payment system using credit/debit cards considered as prior art.

FIG. 2. Is the description of an example embodiment of a 3-party payment system using credit/debit cards considered as prior art.

FIG. 3. Is the description of an example embodiment of an international payments process operated by a Money Transfer Operator (MTO), considered as prior art.

FIG. 4. Is the description of an example embodiment of the structure of a business process using Corresponding Banking Model to achieve the transfer of funds between two countries and considered as prior art.

FIG. 5. —Is the illustration of an example where users chose to use Cryptocurrency to send money.

FIG. 6. —Is an example description of the liquidity problems faced by current processes used today when distributing cryptocurrencies with traditional distribution methods based on exchanges. Said distribution methods are considered to be examples of prior art.

FIG. 7. Is a flowchart that functions as an example of and embodiment of the claimed stable cryptocurrency creation and distribution process.

FIG. 8. Is a block diagram used to illustrate the phases of the life-cycle of a stable cryptocurrency that aims to achieve high throughput and quick finality for transactions as per one embodiment.

FIG. 9. Is an illustration of the roles played by different parties in the processes of tokenized asset creation and transaction validation and propagation using the aBFT and DPOS algorithms.

FIG. 10. Is an illustration of the network composition as defined by the aBFT and DPOS algorithms being used to provide a first, second layer third layer and up to four layers of validation of payment transactions.

FIG. 11. Is an illustration of the general process to implement KYC and AML controls inside the Distributor Account creation process.

FIG. 12. Is an illustration of a specific embodiment of a process and method for using a token to fund inventory loans, that has been parametrized with a commission model and specific interest rates.

### DETAILED DESCRIPTION OF THE EMBODIMENTS

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Various non-limiting embodiments of the present disclosure will now be described to provide an overall understanding of the principles of the structure, function, and operations of a System and methods to process payments and money remittances nearly instantaneously without using financial intermediaries by using a stable cryptocurrency and unconventional cryptocurrency distribution methods. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

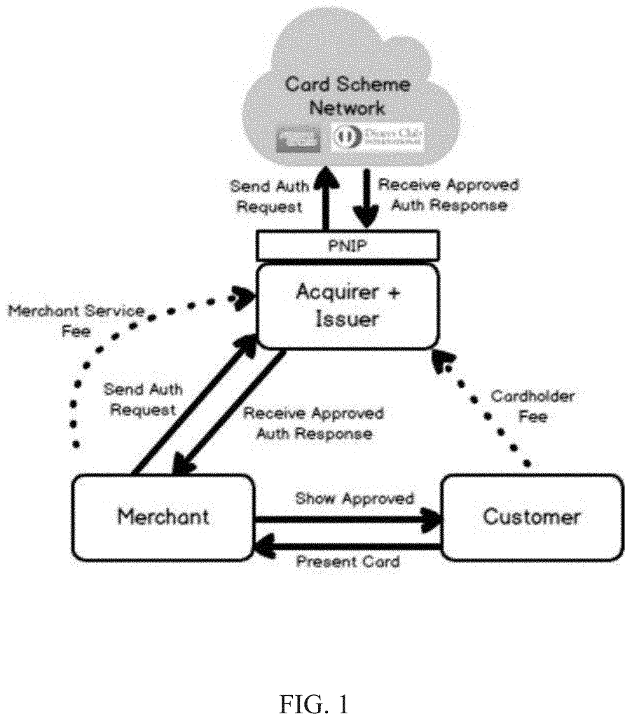

Traditionally, payments are settled with a variety of methods, where many players interact to provide finality and settlement to transactions. One of such arrangements requires the participation of an Acquiring Bank, an Issuer bank, and a Card Network. FIG. 1 illustrates an example embodiment of a payments system using a cards network as described above. In such embodiment, a customer has an account in the Issuer bank, and such account is associated with a plastic card that conforms to the ISO/IEC 7810 ID-I standard. When the customer arrives at the Point of Sale of a merchant in order to make a purchase using the card, the customer presents the card to the merchant, who in turn communicates with his own bank (Acquiring Bank) in order to initiate a transaction. In some embodiments such communication can happen over the phone via a voice call. In other embodiments the communication is established using a variety of devices ranging from modems, network interfaces, the internet or cellular networks. Later, the acquiring bank establishes communication with the Card Network, who is in charge of establishing authentication and providing communication channels with the issuing bank in order to authorize or decline the transaction. Both, the acquiring and issuing banks, make use of a Payment Network Interface Processor (PNIP), which is a specialized apparatus composed of hardware and software used to communicate with the cards network by implementing the ISO 8583 interchange communication standard. In some embodiments the PNIP device is installed directly in the datacenters of the banks. In other embodiments the PNIP device is installed in a third-party datacenter that provides payment processing services to the said banks. Later, the card network performs validations on the requests and forwards the said request to the issuing bank, who in turn checks the Customer's balance associated to his bank account (or credit limits in the case of credit cards) and proceeds to either authorize or decline payment, communicating the decision to the Card Network, who in turn relays the Authorization/Decline message to the Acquiring Bank, and the Acquiring Bank communicates with the Merchant to provide final authorization of the transaction. Such an arrangement allows the Merchant to have a reasonable expectation of achieving transaction finality in some later point in time, that can be anywhere from a few hours, to many days. Mention should be made, that transaction authorization does not automatically translate to transaction finality. Transaction finality only happens when the actual funds are deposited in the Merchant's bank account in the Acquiring bank. Such deposit is subject to inter-bank settlement and reconciliation processes which may fail in many cases.

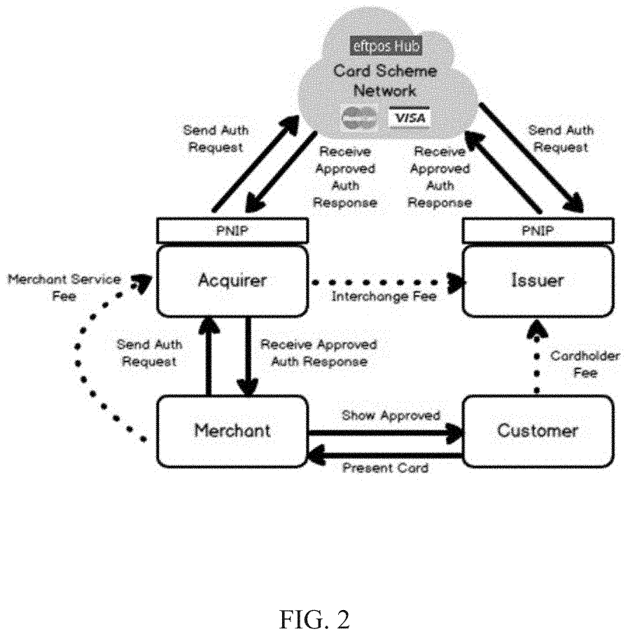

FIG. 2. Illustrates an example embodiment of a payments system where the acquiring and issuing bank are the same, and they also operate a card network. Such an arrangement eliminates the need of interchange fees but has the inconvenience of being a closed network. Both the merchant and the customer need to have an account with the acquiring/issuing bank, which in many cases is inconvenient.

In any case, both examples shown in FIG. 1. And FIG. 2. Require both the Customer and the Merchants to have bank accounts, which constitutes a material impossibility to be used by unbanked people.

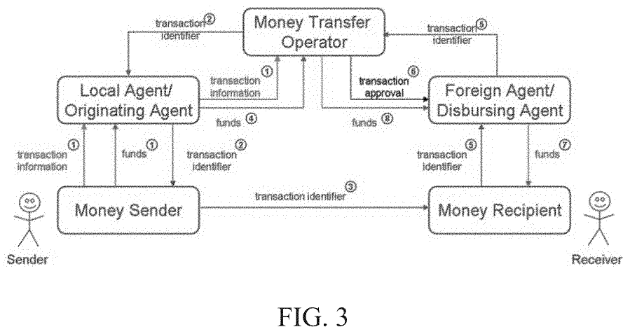

FIG. 3. Illustrates an example embodiment of a money remittance service operated by a Money Transfer Operator using the services of Money Transfer Agents to receive money and disburse money in different locations. In some embodiments the Agents may receive cash, in other embodiments the Agents might receive a bank deposit, in other embodiments the Agents might receive money in the form of a card transaction. In some embodiments the Money Transfer Operator might not use the services of a Money Transfer Agent at all, and in turn resort to the services of an Acquiring Bank to process a card transaction. The specific arrangement shown in the example requires that the Money Transfer Operator has established bank accounts with a standing balance denominated in the local currency for each country concerned in the transaction. In some embodiments of the example, the Money Transfer Operator might rely in Corresponding Bank services in order to maintain a Nostro account in the destination country. In some embodiments, given the delay to process and send actual cash from the Money Transfer Agent to the bank account of the operator, or from the bank account of the operator to the bank account of the Disbursing Agent, an IOU (“I owe you”) mode of operation is used, with final settlement times and risk bearing responsibilities pre-defined by contract between the Money Transfer Operator and the Money Transfer Agents. In some embodiments, both the Money Transfer Operator and the Money Transfer Agents might agree on not finalizing a transaction until all accounts have been reconciliated and settled, which means that the actual availability of funds to the beneficiary party might take several days or even weeks. Furthermore, in the example embodiment shown, cash transactions might be limited to the availability of funds in the receiving location at any given time. In some situations, the Money Transfer Agent might not have enough liquidity to honor payment terms. In other situations, the Money Transfer Operator might face market liquidity problems that mean that he cannot acquire enough local currency at a given time or at a given exchange rate threshold to ensure for a transaction to go through. In such cases, the system completely fails, and the Money Transfer Operator might have to cancel the transaction, even after having received payment from the customer.

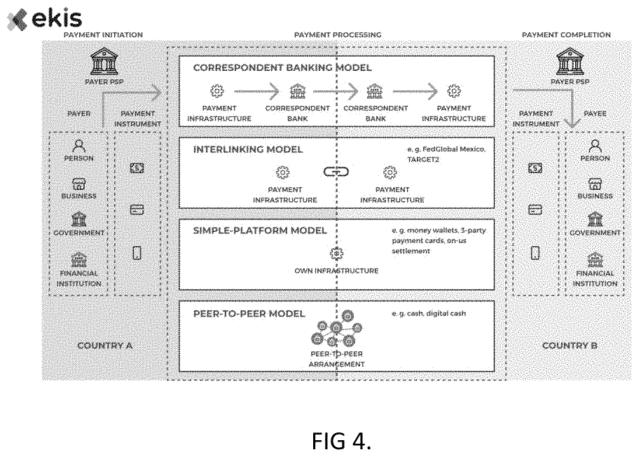

FIG. 4. Illustrates an example embodiment of a method to send money between two distinct bank accounts in different countries. This method relies on the fact that one of the banks (the sending bank) has an account in the other bank, and that that account has been pre-funded and holds reserves for at least the amount of money to be sent. The bank holding the balance is called the corresponding bank. In some embodiments this type of arrangement can provide almost instant transfer of funds from the point of view of the customer, only limited by the amount that has been pre-funded in the nostro account of the sending bank that sits on the corresponding bank balance as a liability. However, in most embodiments of this example, banks require the customer to have an open account with them to either send or receive money, which constitutes a material impossibility to transact for the unbanked population. Furthermore, not every sending bank holds corresponding agreements with all of the banks in the receiving end, so in many embodiments, in order to send money to a specific bank account with a bank with no standing corresponding relationship with the sending bank, the sending bank must go through intermediaries that have corresponding relationships themselves with the destination bank. Such an arrangement might mean that in many embodiments more than two banks participate in a transaction, delaying the transfer of value in each hop, and extracting commissions associated with the service provided.

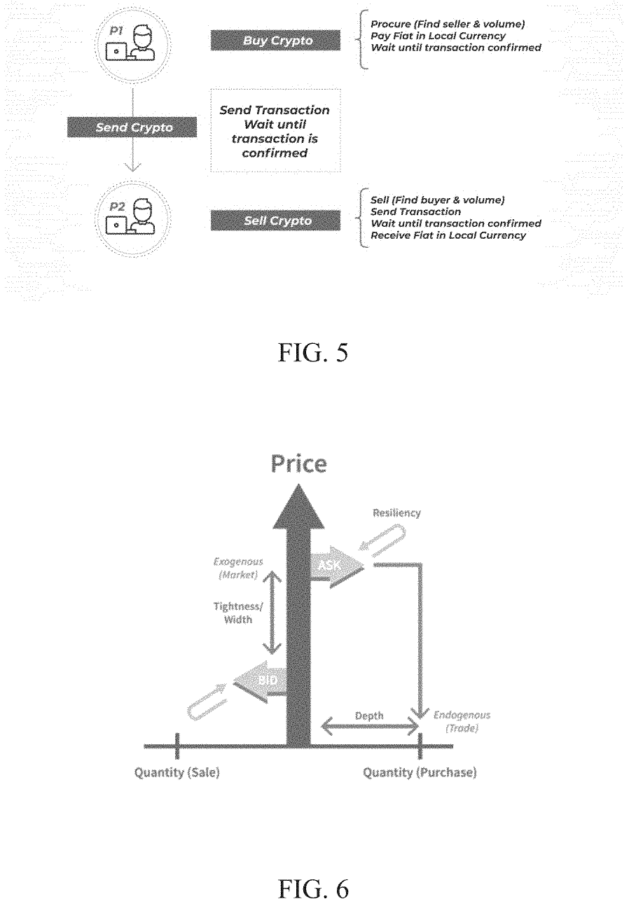

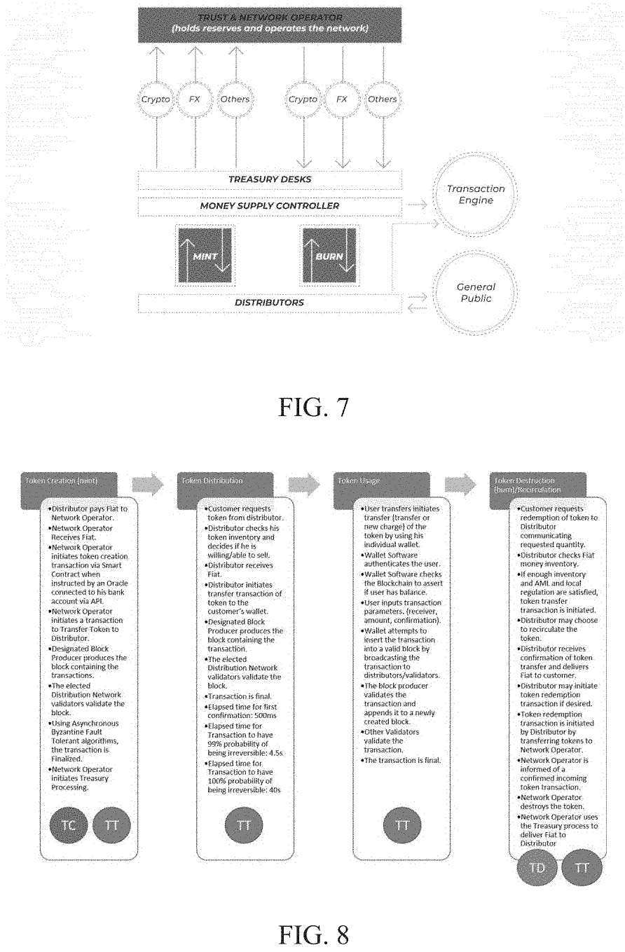

As illustrated in FIG. 5, customers might resort to the use of cryptocurrencies in order to avoid the associated delays and commissions involved in a traditional international money transfer transaction. Such an arrangement is problematic for the following reasons.

In some embodiments of the example shown in FIG. 5. the users might choose to use Bitcoin to transfer funds. There is at least one method allowing a person to buy Bitcoin using fiat money and without the intervention of banks as intermediaries. However, in order to implement such a method, an unbanked person would need to find a seller of Bitcoin who agrees to sell the exact amount of Bitcoin that the person wishes to send in exchange for cash, a task which in itself might prove to be very difficult or even impossible in the market. If no single individual is willing or able to “fill” the purchase of Bitcoin, the sender would have to search additional sellers of Bitcoin up to the amount that he wishes to purchase in Bitcoin to send them. If we are to assume the sender is able to find the exact amount of Bitcoin needed for the transfer, then, once the sale of Bitcoin has been agreed and the parties begin the transaction, up to six confirmations from the Bitcoin network are usually required by purchasers of Bitcoin to assume finality, which amounts to a delay of one hour at least per initiated transaction (remember it might take several to complete the amount). Mention should be made that in all embodiments that use a cryptocurrency such as Bitcoin in particular or any similar embodiment that uses a Proof of Work algorithm to create transactions (such as Ethereum), transaction finality is not achieved in a deterministic way, and is only achieved artificially as a convention between the parties. There are embodiments and scenarios that under specific circumstances might mean that a transaction is never final and can be undone. When using Bitcoin, transaction finality can be asserted to a probability that can be as high as 99.99999999%, however, because of design constraints, it can never reach 100% certainty. Once the purchase of Bitcoin is “reasonably” confirmed, the person wishing to send money could initiate a second transaction to send the purchased Bitcoins to the receiver. This second transaction is subject to the same initial delays and finality confirmation problems as the first transaction to buy Bitcoin. Furthermore, in the receiving end, the person that receives Bitcoin most likely will not be able to spend them immediately, as very few merchants accept Bitcoin as a valid means of payment. The person receiving Bitcoin would have to resort to selling them in exchange for Fiat money, once again facing the problem of finding a person willing to exchange cash for Bitcoin, in the amounts that the seller wants to sell. In essence, the same initial operation in reverse with the same challenges and complications. Because of all these issues, Bitcoin is not a viable solution for most of the unsophisticated unbanked population.

In some embodiments of the example shown in FIG. 5. the sender and receiver might use other cryptocurrencies such as Ethereum, Ripple, Dogecoin in order to settle a transaction, these alternative cryptocurrencies generally exhibit better transaction times and might even offer 100% finality, however, in most of these embodiments the seller would need again to procure the said cryptocurrency from a seller which is problematic and cumbersome to do if one is unbanked.

Mention should be made, that in the specific embodiments of cryptocurrencies that work under the category of being implementations of the Proof of Work family of consensus algorithms, if one wishes to procure cryptocurrency one can do so by committing computational resources to solving mathematical problems and validating transactions, an action commonly known as “mining”, skipping the need to procure the asset from a third party. However, having said that, “mining” is an activity that by its nature and design is slow, requires large amounts of energy, is not environmentally friendly, generates large amounts of heat and noise and requires specialized computational equipment that is very expensive and faces quick obsolescence, as the mathematical complexity of the challenges is programmatically increased over time. It is perfectly possible to perform mining as a mean to procure cryptocurrencies, but simply put it is not viable to do so at the small scale required to fund everyday individual transactions.

In some embodiments, and for many of the existing cryptocurrencies, the procurement problem can be solved by using a Cryptocurrency Exchange Service over the Internet, which allows either for the direct purchase of Cryptocurrency using a bank account or card, at a premium over market prices, or the purchase of Cryptocurrency from peers participating in the exchange's marketplace. Again, this alternative is materially impossible to implement for someone unbanked. However, assuming the sender gains access to an exchange, when transacting in the exchange, and depending on the specific volumes of cryptocurrency being sold and purchased individually in each instance, the person wishing to purchase cryptocurrency could face volatility and liquidity problems that make such a purchase inconvenient or even impossible, as typically only certain amounts of cryptocurrency can be purchased at the cheapest price, and the majority of cryptocurrency being offered for sale, is typically offered at much higher prices. The underlying problem in this embodiment is graphically illustrated in FIG. 6.

In order to overcome the previously discussed limitations, we document a new arrangement of business processes and technologies that allow an unbanked person to execute electronic transfers of economic value (payments/remittances), as well as allowing businesses to receive payments from such persons and also using said transferred economic value to make purchases and payments as needed by using a new cryptocurrency implemented in a blockchain or Distributed Ledger Technology. We also provide mechanisms to allow for value redemption into Fiat money.

As illustrated in FIG. 8, such an arrangement would consist of:

A legal means of value storage of fiat money: A business chartered as a Limited Purpose Trust Company that is tasked with the reception, administration and delivery of funds on behalf of beneficiaries. In some embodiments said trust could also obtain licenses to operate as a bank. In some embodiments said trust could also obtain licenses of any form to operate as a money transmitting business. In some embodiments said trust might not adopt a previously defined legal form, however retaining its functions. Said business is also otherwise referred to in this document as the Network Operator.

A means of digitally representing the funds being managed by the trust as well as the transfers of value between the users of such a system. This is achieved by a system using Distributed Ledger Technology (DLT) or Blockchain to store immutable information about the money held in trust, the tokenization (digital representation of the money, as governed by a Money Supply Controller component), the circulation of the tokenized asset as the representation of the money being transferred between users by means of digital transaction storage by a transaction engine, as well as the delivery of fiat money back to the beneficiaries when the tokenized assets are burned or redeemed.

A business process to distribute tokenized assets to the public by means of a distribution network that also works as an integral part of the architected systems to validate transactions of the tokenized asset.

A system that uses a specific combination of consensus algorithms used in the DLT or Blockchain to secure each transaction performed with the tokenized asset in the specific context of transfer of value, not allowing for the general Turing complete execution of instructions that typically is implemented in general purpose Blockchains or DLT's.

A Treasury business system determined by a process to move received fiat money in one currency and depositing said money in the reserves held under trust in another currency. In one embodiment the reserves could be held in United States Dollars. In some embodiments the reserve could be held in currencies other that United States Dollars. In some embodiments the treasury business system might use a Foreign Exchange (FX) trading desk. In other embodiments the treasury business system might use a Cryptocurrency Trading Desk. In other embodiments the Treasury business system might use other trading alternatives in connection with its purpose of moving money, including using third party services or any combination of processes or techniques used simultaneously or separately. In some embodiments the reserve could be held in any compound combination of currencies. In other embodiments the reserve could be held in other type of assets that represent value, alone or in combination, such as contracts, options, futures, metals or any other type commodities or financial derivatives.

In another embodiment the Treasury business systems, comprising; an Order Execution Engine, Pricing Systems, and Oracles to communicate with blockchain, that would ensure that for every unit of fiat money deposited to the Network Operator's bank account, a corresponding unit of Fiat would be deposited into a Trust account in a designated currency, and the corresponding unit of cryptocurrency by Token Creation, would be created and delivered to the depositor of fiat into his electronic wallet.

A system or combination of technologies used in connection with the distribution process by the distributors to provide a means to account for inventories of the tokenized asset, the sale of the tokenized asset, or the reception of the tokenized asset. This system or combination of technologies will be further called the Distributor's Wallet.

A system of combination of technologies used in connection with the transfer process by end-users. Such a system would allow users to transact, either by reading transactions stored in the DLT, or requesting a new transfer transaction from the DLT network to be included in the Blockchain.

In some embodiments of the system and methods represented in FIG. 8. The operator of the Trust might act as its own distribution network, buying, distributing, and burning a tokenized digital asset from itself with its own fiat money.

In some embodiments of the system and methods represented in FIG. 8. The operator of the Trust might act as a member of the General Public, using the tokenized digital asset to perform transfers of value or purchases.

In some embodiments of the system and methods represented in FIG. 8. The operator of the Trust might act as a validator of transactions in itself or in other embodiments in cooperation with the validators from the distribution network. In one embodiment the operator of the trust may not act as a validator of transactions.

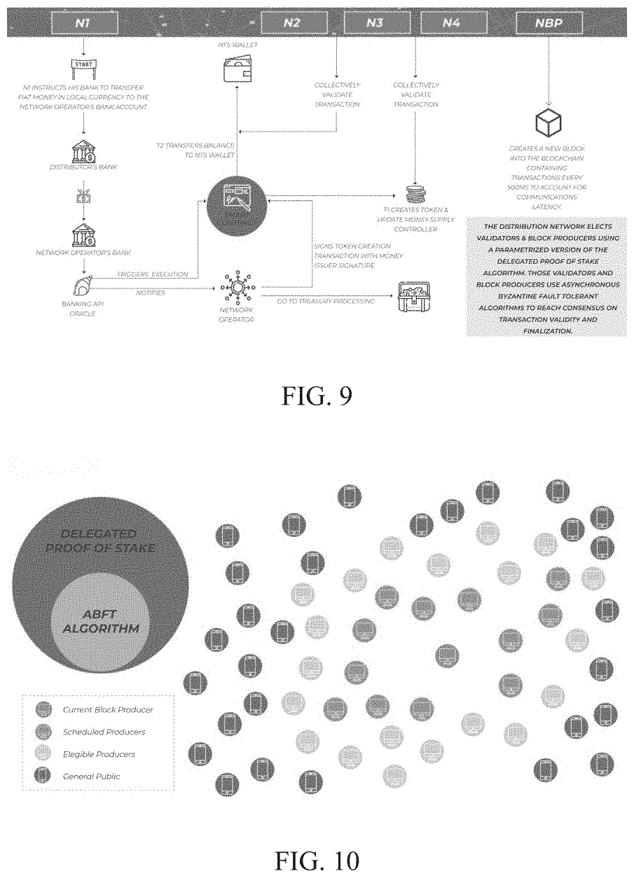

As illustrated in FIG. 9. The general life-cycle of the tokenized asset is as follows. Token Creation.

A member of the distribution network wishes to acquire inventory of the tokenized asset.

In order to receive the tokenized asset, the member of the distribution network makes a bank deposit in its locally denominated currency to purchase the tokenized asset (also visible in FIG. 10).

The Network Operator receives the locally denominated currency and is informed by its own bank after the fact via API (Application Programming Interface). In some embodiments the bank notification might arrive by any combination of electronic means, including computer applications, SMS, WhatsApp messages, EDI, or even via phone notification. In specific, the piece of software technology that allows for verification of an off-chain event, and triggers the execution of an in-chain action, in DLT and Blockchain technologies is called an Oracle. In some embodiments one oracle can be used to automatically check the status of a bank account. In other embodiments the oracle might need to be used manually by an operator. In essence, we could say that there are as many embodiments of an Oracle as there are possible means communication between the bank and the Network Operator.

The Network Operator, triggers the execution of a smart contract that implements a Money Supply Controller function to mint a new unit of value denominated in the tokenized asset and to transfer it to the correct distributor's wallet.

A “mint” transaction is queued for inclusion into a DLT or Blockchain block.

The smart contract sends a “transfer” transaction for inclusion into a DLT or Blockchain block.

A designated block producer validates the transaction and includes it into a newly created block containing both the mint and transfer transactions. In some embodiments the mint and transfer transactions might be included in separate blocks, produced by the same or different block producers, however it is a strict requirement that in those embodiments the mint transaction is included in a block preceding the transfer transaction, as the transfer transaction would fail to execute if there is no prior associated mint transaction.

The delegated validators who have been previously elected by means of a Delegated Proof of Stake election system and methods with the objective of reaching a very quick consensus, validate the newly created block by using an Asynchronous Byzantine Fault Tolerant system and methods, that are implemented as a means of achieving very quick and deterministic transaction finality. In other embodiments, the selection of validators might work under a different principle, or there could be a sole validator. In other embodiments, different types of Byzantine Fault Tolerance algorithms could be used. In other embodiments, new, yet to be invented consensus algorithms could plausibly be used. However, in all embodiments the objective shall remain the same: to provide transaction consensus and deterministic transaction finality in the quickest and most efficient way possible.

### Token Distribution

A customer approaches a distributor with the intention of buying the tokenized asset that invariably must exist in the inventory and wallet of the distributor, who obtained it by the processes, systems and methods specified in the token creation phase. In other embodiment, the distributor might have obtained an inventory of tokenized assets in a different way, for example as a result of the transfer of the tokenized asset from a third party. In other embodiment the distributor might have obtained the inventory in a combination of the above embodiments. However, in all embodiments the first operation that needs to occur before token distribution is necessarily token creation, even if the current distributor was not the one originally triggering the token creation. We call this last variant embodiment “redistribution”.

The distributor checks if according to his liquidity management strategy and current agreements in place with the Network Operator, he is allowed to sell the tokenized asset and how much of it. In some embodiment of this scheme, the distributor might be required to always honor a certain level of liquidity. Furthermore, in some embodiments the distributor might have borrowing agreements with other distributors and even with the Network Operator itself to maintain instant or revolving credit lines in order to maintain liquidity denominated in the tokenized asset. If he is allowed to sell at least the amount that the customer is willing to buy, the distributor takes the equivalent amount of fiat money as cash from the customer, prized at the rate indicated by the distribution wallet software. In other embodiments of the distribution, a distributor might accept other forms of payment different from cash, such as bank deposit, credit or debit cards, alternative payment methods, cryptocurrency, payment in kind, or any other payment method susceptible to be prized in the tokenized asset. In some embodiments the operation can be further automated by using Automated Teller Machines or similar apparatuses that would implement all of the operations associated with the distribution without human intervention. In other embodiments the distributor might operate online and will only take electronic payments. In order to proceed with the transfer of the token to the customer's wallet, the distributor will capture the unique identifier code of the customer's wallet. This identifier code may be communicated verbally by the customer, and will typically be identical to the cell phone number of the customer, where the actual wallet has been previously installed or will be installed. In some embodiments the unique identifier code might be communicated electronically or optically by use of bar-code scanning, QR codes, SMS, Near Field Communications, Bluetooth, Direct Push Notification, or by typing into a keyboard, pinpad, or touchscreen or any other that is connected to either the customer's phone, or the distributor's distribution device with the distribution wallet installed. The distributor would then proceed to capture the amount of fiat he received and send a transfer transaction request to the network with the captured details. The transfer transaction request will immediately be broadcasted by the distributor's wallet to the subset of elected validators of the network that have been chosen using the Delegated Proof of Stake election process. The elected validators include at least one block producer tasked with producing a valid block containing a group of transactions as per the Asynchronous Byzantine Fault Tolerant algorithm. In other embodiments different algorithms might be used that achieve the same objectives of transaction finality and speed. The designated block producer receives the transaction, and outputs a valid block that is broadcasted to the network. The remaining validators validate the produced block and reach consensus using the Asynchronous Byzantine Fault Tolerant algorithm. According to known implementations of the algorithm's specification, a transaction occurring in this manner would receive its first confirmation (block production) in about 500 ms, it would reach a 99% probability of being irreversible in 4.5 seconds and would be considered deterministically irreversible after 4.5 seconds, and would be considered final with 100% probability (deterministic finality) after 40 seconds, having been confirmed asynchronously by the delegated validators. Given the workings of the Delegated Proof of Stake and Asynchronous Byzantine Fault Tolerant algorithms, the transaction can probably be considered final in practical terms after just 500 ms, as it is very implausible that consensus will not be reached by validator nodes once a block has been produced. In other embodiments other consensus algorithms, systems, processes and methods might be utilized, in the case that they represent significant efficiencies in cost, speed or security to what has been described here.

### Token Usage

Token usage is in essence a token transfer operation, that behaves algorithmically identically to the transfer operations inside in the Token creation and Token Distribution Phases, the only difference being the intent of the actors participating in the transactions and the convenience and functionalities available as provided by specialized software applications and hardware devices used to facilitate communications and ease of use between the actors and with the network. Typically, the actors participating in token usage are regular peers (individual people), customers and merchants. In different business contexts a certain individual might act with a different role. In one transaction embodiment, a person might choose to transfer the tokenized asset to a peer (a remittance, that might be local or international). That same person in other embodiment might use the tokenized asset to purchase goods or services from a merchant, in which case the person would be considered a customer. In other embodiments of a transaction a person would be considered a merchant, in case he or she is selling a product or service and receiving a tokenized asset as means of payment. Specialized software applications and even different hardware platforms could be used in each embodiment that would have access and specialized permissions pertaining to the tokenized assets belonging to the person (for example, a specific wallet implementation for merchants could allow only for the reception of payments in tokenized asset, but not having an active transfer functionality, so the merchant's employees could not possibly spend the received funds). Furthermore, some embodiments of the systems and methods provided to access the tokenized asset might include Multi-Signature wallets, shared access, permissioned accounts, external connections to ERP software, Personal Finance Management Implementations, Permissions Management Systems etc. Subject to the same considerations than in other phases, other embodiments might exist that make use of other algorithms different to Delegated Proof of Stake and Asynchronous Byzantine Fault Tolerant algorithms.

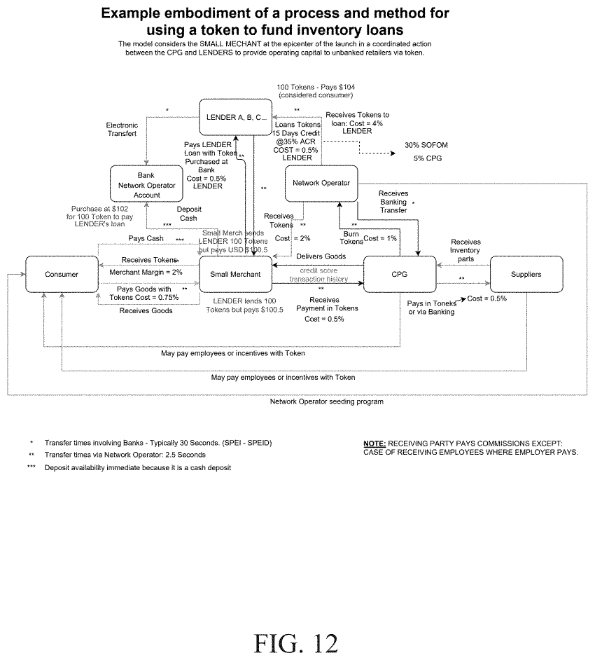

In at least one embodiment retail merchants may use tokens to pay for inventory orders to wholesalers or producers instead of using fiat money, reducing the need for slow and costly cash management processes such as collection, transport, insurance, reconciliation and others, as no cash is involved in the electronic transaction. Having a complete, trustable and detailed history of transactions between retail merchants and wholesalers or producers would enable the creation of a global credit scoring system and reverse factoring, inventory lending and other financing capabilities that are currently inaccessible for those retail merchants operating without bank accounts. As exemplified by FIG. 12, one can build such a system stablishing diverse fee structures and incentives, in particular the example embodiment shows a system where an external group of potential, registered lenders, buy tokens to lend them to small merchants based on a credit analysis of past supply flows between CPG's (Consumer Packaged Goods companies) and their intermediate customers. Other embodiments could make use of wholesale companies, wholesale token distributors to improve liquidity of the system, or any other type of actor that is allowed to transact inside the supply chain. There are embodiments where automated liquidity pools can be programmed into the smart contracts that allow for automated credit allocation without human intervention. There is at least another embodiment where tokens are not burned (destroyed), but instead they are recirculated as it is discussed later.

### Token Destruction or Recirculation

Token destruction as illustrated in FIG. 9 refers to a process that is “inverse” in nature, implementation and results to the Token Creation process. One could also refer to it as an asset detokenization process. The objective of Asset Destruction is to make cash available to a person in exchange for tokenized assets at a distribution point, and to settle a final redemption of fiat money to a distributor. As this said cash is ultimately held in a reserve under trust, and must move out of it, and the tokenized assets are a digital representation of said cash in reserve, whenever money is removed from the reserve, its digital representation must cease to exist. Mention should be made that there is an embodiment where a distributor receiving a tokenized asset might choose to hand out cash to a person that delivers a tokenized asset for redemption without asking for ultimate redemption for itself. A first, public facing redemption is achieved when the distributor receives the tokenized asset and delivers the corresponding cash, however, the distributor might choose not to request itself the redemption of the asset to the Network Operator which would be the final step in the lifecycle of the tokenized asset, instead, said distributor can choose to account for the newly acquired asset as new inventory, either to be distributed again (at a gain, because minting costs would no longer apply) or to be used in purchases or transfers, in which case, no tokenized asset would need to be destroyed, and no money would leave the reserves under trust. We call this specific embodiment the Recirculation process. Subject to the same considerations than in other phases, other embodiments might exist that make use of other algorithms different to Delegated Proof of Stake and Asynchronous Byzantine Fault Tolerant algorithms.

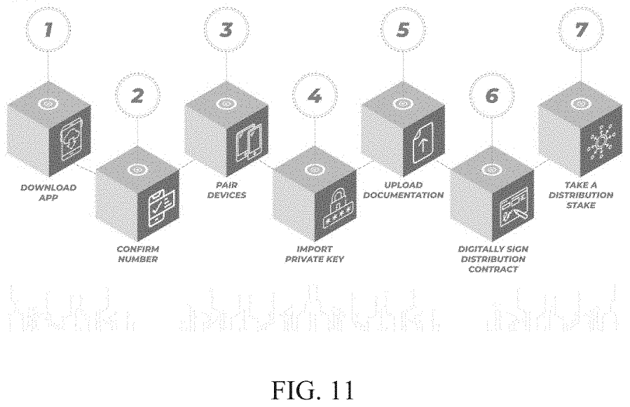

As illustrated in FIG. 11. The network members can be classified as Current Block Producer, Scheduled Block Producers/Validators, Eligible Block Producers, and General Public. Mention should be made that all categories except for General Public are considered to be Distributors. If there's a merchant that does accept a tokenized asset, but does not participate with an active distribution agreement, and only uses the asset to purchase goods or services, or to transfer said asset to third parties, its involvement is considered to be equivalent to that of the general public from al algorithmic perspective (although its treatment would be different business wise). That means that such a user would not be eligible to produce a block, would have no vote on the network governance and consensus, and would not be contractually entitled to charge a fee to end users for the distribution of the tokenized asset. Such a classification of users is necessary from al algorithmic point of view in order to obtain consensus, communicate and verify transaction validity, integrity, security and finality with sufficient speed and reliability as to be considered a viable payment method that can interact with the General Public without the use of the current bank-centric methods. Furthermore, the aBFT (Asynchronous Byzantine Fault Tolerant) and DPOS (Delegated Proof of Stake) algorithms have been selected for its use in this embodiment for their ability to comply to the specification of what's needed to implement a viable transactional business process. This is equivalent to say that such algorithms can achieve the transactional objectives of the business process, however on its own, they cannot solve the asset procurement, liquidity, stability and acceptance at the merchant's point of sales problems that are inherent to other existing DLT, Blockchain and cryptocurrency-based solutions, either based on aBFT and DPOS, or relying in other protocols like Proof of Work, such as Bitcoin and Ethereum and its derivatives. To a person sufficiently skilled in the art, it is evident that the use of such algorithms is a technical construct that is necessary in today's world to obtain a set of desired attributes that no other solution currently exhibits, however this only allows for a partial solution. The additional and original addition of “real world distributors” doubling its real-world role of handling money, maintaining inventory, communicating with the network operator to stablish reserves, distributing the tokenized asset and finally redeeming it, coupled with their algorithmically defined role as block validators, block producers, scheduled block producers or eligible block producers solves the full set of problems that have been exposed. Because the aBFT and DPOS algorithms are published public knowledge and have been known for several years, and because both are well known to those of ordinary skill in the art, no further explanation is needed about their workings.

As illustrated in FIG. 11. We can see the distinct set of steps that a distributor must follow in order to start working as such inside the network. Typically, the distributor would start the process by downloading a software application to his/her mobile phone. After successful installation of the software application, the user would be prompted to verify his/her phone number, which could be implemented by various methods, such as asking permission to read SIM Data, requesting permissions to send SMS and sending an SMS back to the Network Operator, sending of (One Time Password) OTP codes to the stated phone number via various methods such as SMS or WhatsApp, voice recitation of an OTP over a phone call initiated by the user, etc. Afterwards, the user would be prompted to install the software in any other additional devices where they would make valid use of the wallet or would install the software implementing the aBFT and DPOS algorithms and the roles necessary to perform the algorithmically designated functions that a distributor needs to undertake. After such installation, the candidate distributor would be prompted to copy self-send private key signed message between devices to prove he/she is in control of all devices that have an active installation of the software. This is what we call “importing the key”. When all of the intended devices are up and ready, the user is prompted to provide their registration details, that might include various pieces of information, including textual information and verification information, that would be typically comprised of pictures, pictures of official documents, voice signatures, fingerprints, iris scans and other biometric or documental information, as needed to stablish certainty over the person's identity as mandated by KYC and AML regulations. The user would then be prompted to use their Private Key to digitally sign the contracts that govern its relationship with the Network Operator and with the public. After all this information has been sent back to the Network Operator, and checked for integrity, validity and against various databases that may include Money Laundering Databases, Designated Terrorist Organizations, as mandated by law, the network operator would then approve the operation of the software and the creation of a valid account with distributor privileges. The newly created distributor would then be prompted to provide funds to acquire inventory and place a stake (the stake is based on the rolling value of the committed inventory) in the distribution system.

In a preferred embodiment of the invention comprises a wallet application, which is a cryptographic mechanism that may run on a mobile smartphone, or any other type of computing platform connected to the Internet, that allows anyone interacting with the Blockchain, to authenticate by using biometric technology or other authentication mechanisms and send signed transactions for inclusion into the Distributed Ledger or DLT, such transactions will implement the Token Creation, Token Transfer (usage) and Token Burn subfunctions as determined in a Smart Contract, the wallet application will also allow the person using it to access balances and transaction history associated to their account.

In another preferred embodiment of the invention comprises a system to implement payment or remittances to create, transfer and burn the stable cryptocurrency to be distributed for the use of the unbanked population, wherein said system would consist of a Blockchain or DLT sub-system implementing, a set of smart contracts that govern the behaviour and functions of the cryptocurrency, and an arrangement of underlying algorithms, such as Byzantyne Fault Tolerant and Delegated Proof of Stake, that allow for fast transaction execution and finality within the parameters of the designed system, in contrast with current slow, uncertain or expensive systems that exist in the payments landscape.

In an essential embodiment the invention discloses a method to distribute a stable cryptocurrency for the use of the unbanked population for payment or remittances operations, wherein said method comprising: Create a Token; Distribute a token; Transfer or use a Token; Implement a treasury business system, and: Destruction or recirculation a token.

In another essential embodiment of the invention discloses a system that implements payment or remittances operations comprising; a token creation, a token distribution, a token transfer or usage, a treasury business system, a token destruction or recirculation and a wallet application, in order to allow persons and businesses to transact almost instantaneously without the use of bank accounts or cards or cash, and not using other cryptocurrencies such as Bitcoin or Ethereum that lack transactional speed and are inherently price-unstable or have expensive transaction fees, by distributing a stable cryptocurrency for the use of the unbanked population.

In other preferred embodiment of the invention comprises a method that involves a network of merchants that individually deposit cash to the Network Operator's bank account in order to obtain a certain amount of cryptocurrency, as determined by a treasury business system.

In another preferred embodiment of the invention includes a method wherein a distributor obtains a unique identifier from the network and is approved to transact by a network operator, once he has completed a specific process to be onboarded and its identity can be verified by the network operator in accordance with company and government mandated KYC-AML regulations.

In other preferred embodiment of the invention discloses a method distributors to implement token burn and redemption, or token recirculation, depending on their needs, by transferring tokens to the Network Operator's designated Token Burning account, after the designated Oracles have confirmed the deposit into the bank account of the distributor and by means of a Smart Contract and the Treasury Systems will deposit Fiat to the distributor's bank account and will burn the deposited tokens, whenever the distributor wishes to recirculate the tokens instead of burning them, he will be given the option to sell said tokens to the general public using a specialized transfer function

In other preferred embodiment of the invention includes a method that allows for general public onboarding and identity verification that further allows anyone to use the systems or wallets, provided that such person has a valid and unique phone number as well as a verifiable ID, to enroll into the network and be enabled to purchase the cryptocurrency from a distributor or receive or send such cryptocurrency from and to other third parties with a verifiable identity.

In another preferred embodiment of the invention the actors of a supply chain use the stable cryptocurrency to provide financing options to unbanked or underbanked business or persons. Such method would involve buying cryptocurrency in order to lend it, and obtaining a list of recommended businesses to be lent, confirming transactional history using the Blockchain or DLT to take credit decisions, executing automated smart contracts that take the burden of the credit decision from the lender and automate the process and transferring the lent amount to the beneficiary of the loan.

1. A system that implements payment or remittances operations comprising; a token creation, a token distribution, a token transfer or usage, a treasury business system, a token destruction or recirculation and a wallet application, in order to allow persons and businesses to transact almost instantaneously without the use of bank accounts or cards or cash, and not using other cryptocurrencies such as Bitcoin or Ethereum that lack transactional speed and are inherently price-unstable or have expensive transaction fees, by distributing a stable cryptocurrency for the use of the unbanked population.

2. The system to implement payment or remittances operations of claim 1 wherein the Treasury business systems, comprising; an Order Execution Engine, Pricing Systems, and Oracles to communicate with blockchain, that would ensure that for every unit of fiat money deposited to the Network Operator's bank account, a corresponding unit of Fiat would be deposited into a Trust account in a designated currency, and the corresponding unit of cryptocurrency by Token Creation, would be created and delivered to the depositor of fiat into his electronic wallet.

3. The system for implement payment or remittances operations of claim 1 wherein of the wallet application, is a cryptographic mechanism that may run on a mobile smartphone, or any other type of computing platform connected to the Internet, that allows anyone interacting with the Blockchain, to authenticate by using biometric technology or other authentication mechanisms and send signed transactions for inclusion into the Distributed Ledger or DLT, such transactions will implement the Token Creation, Token Transfer (usage) and Token Burn subfunctions as determined in a Smart Contract, the wallet application will also allow the person using it to access balances and transaction history associated to their account.

4. The system to implement payment or remittances operations of claim 1 to create, transfer and burn the stable cryptocurrency to be distributed for the use of the unbanked population, wherein said system would consist of a Blockchain or DLT sub-system implementing, a set of smart contracts that govern the behaviour and functions of the cryptocurrency, and an arrangement of underlying algorithms, such as Byzantyne Fault Tolerant and Delegated Proof of Stake, that allow for fast transaction execution and finality within the parameters of the designed system, in contrast with current slow, uncertain or expensive systems that exist in the payments landscape.

5. A method to distribute a stable cryptocurrency for the use of the unbanked population for payment or remittances operations, wherein said method comprising:
Create a Token;
Distribute a token:
Transfer or use a Token;
Implement a treasury business system, and;
Destruction or recirculation a token

6. The method of claim 5 that involves a network of merchants that individually deposit cash to the Network Operator's bank account in order to obtain a certain amount of cryptocurrency, as determined by a treasury business system.

7. The method of claim 5, wherein a distributor obtains a unique identifier from the network and is approved to transact by a network operator, once he has completed a specific process to be onboarded and its identity can be verified by the network operator in accordance with company and government mandated KYC-AML regulations.

8. A method of claim 7 for distributors to implement token burn and redemption, or token recirculation, depending on their needs, by transferring tokens to the Network Operator's designated Token Burning account, after the designated Oracles have confirmed the deposit into the bank account of the distributor and by means of a Smart Contract and the Treasury Systems will deposit Fiat to the distributor's bank account and will burn the deposited tokens, whenever the distributor wishes to recirculate the tokens instead of burning them, he will be given the option to sell said tokens to the general public using a specialized transfer function.

9. The method of claim 5, that allows for general public onboarding and identity verification that further allows anyone to use the systems or wallets, provided that such person has a valid and unique phone number as well as a verifiable ID, to enroll into the network and be enabled to purchase the cryptocurrency from a distributor or receive or send such cryptocurrency from and to other third parties with a verifiable identity.

10. The method of claim 5, wherein the actors of a supply chain use the stable cryptocurrency to provide financing options to unbanked or underbanked business or persons. Such method would involve buying cryptocurrency in order to lend it, and obtaining a list of recommended businesses to be lent, confirming transactional history using the Blockchain or DLT to take credit decisions, executing automated smart contracts that take the burden of the credit decision from the lender and automate the process and transferring the lent amount to the beneficiary of the loan.
